(19) United States
(12) Patent Application Publication
(10) Pub. No.: US 2022/0007158 A1
(43) Pub. Date: Jan. 6, 2022

(54) NEW GRANULARITY FOR IoT DATA TRANSFER FOR ANALYTICS

(71) Applicant: NOKIA TECHNOLOGIES OY, Espoo (FI)

(72) Inventors: Gerald GOERMER, Wandlitz (DE); Maryse GARDELLA, Velizy (FR)

(21) Appl. No.: 16/490,160

(22) PCT Filed: Mar. 15, 2017
(86) PCT No.: PCT/EP2017/056147

§ 371 Date: Aug. 30, 2019

(51) Int. Cl. H04W 4/24; H04L 12/14; H04M 15/00

(52) U.S. Cl. CPC H04W 4/24; H04L 12/1407; H04L 12/1425; H04M 15/66; H04M 15/64; H04M 15/81; H04M 15/852; H04M 15/61

(57) ABSTRACT

It is provided a method, comprising monitoring if one of an input payload for a subscription and an output payload from the subscription is delivered; incrementing a payload counter by if one of the input payload and the output payload is delivered; providing the payload counter and an identifier of the subscription to a charging system at at least one of a predefined time and a predefined event.

### FIELD OF THE INVENTION

The present invention relates to an apparatus, a method, and a computer program product related to coverage enhancement. More particularly, the present invention relates to an apparatus, a method, and a computer program product related to authorization for coverage enhancement.

### Abbreviations

### 3GPP Third Generation Partnership Project

### 4G 4^{th} Generation

### 5G 5^{th} Generation

### ADC Administration Center

### AF Application Function

### AMF Access and Mobility Management Function

### APN Access Point Name

### AVP Attribute-Value Pair

### CC Charging Characteristics

### CDR Charging Data Record

### CIoT Cellular IoT

### CP Control Plane

CSG Closed Subscriber group

### DCCA Diameter Credit Control Application

### EC-GSM-IoT Extended Coverage-GSM-IoT

### EPC Evolved Packet Core

### EPS Evolved Packet System

### GGSN Gateway GPRS Support Node

### GPRS General Packet Radio System

### GSM Global System for Mobile Communication

### IETF Internet Engineering Task Force

### IP Internet Protocol

### IP-CAN IP Connectivity Access Network

### IoT Internet of Things

### LAN Local Area Network

### LoRaWAN Local Radio WAN

### LTE Long Term Evolution

### LTE-A LTE-Advanced

### LTE-M LTE Machine-to-Machine

### LPWA Low Power Wide Area

### MIoT Mobile IoT

### MME Mobility Management Entity

### MNO Mobile Network Operator

### NB-IoT Narrowband IoT

### NEF Network Exposure Function

NIDD Non-IP data Delivery

### OCS Online Charging System

### OFCS Offline Charging System

### PCEF Policy and Charging Enforcement Function

### PDN Packet Data Network

### PDU Protocol Data Unit

### PGW Packet Gateway

### PLMN Public Land Mobile Network

### QoS Quality of Service

### RAT Radio Access Technology

### RFC Request for Comments

### RPMA Random Phase Multiple Access

### SCEF Service Capability Exposure Function

### SDF Service Data Flow

### SMF Session Management Function

### SGSN Serving GPRS Support Node

### SGW Serving Gateway

### TDF Traffic Detection Function

### TS Technical Specification

### UE User Equipment

### UP User Plane

### UWAN User Wide Area Network

### WAN Wide Area Network

### WiFi Wireless Fidelity

### WLAN Wireless LAN

### BACKGROUND OF THE INVENTION

3GPP specified, under CIoT EPS optimization (3GPP TS 23.401), a new function known as Service Capability Exposure Function (SCEF) allowing to bridge between NB-IoT devices sending small Non-IP application data to the IoT server (in FIG. 1a named “Intermediary server” and/or “Application server”) and the 3GPP core network, in FIG. 1a represented by MME, SCEF, SGW and PGW. This is a new transfer option, in addition to the existing transfer of IP packet data from mobile devices over GGSN/PGW(PCEF) via the IP interworking interface Gi/SGi to service provider. The invention also covers the case where the payload counting is performed by a TDF upon application detection.

This invention also covers IP and non-IP small data delivery by 5G Core Network (3GPP TS 23.501), in particular when this 5G Core Network will be defined with capabilities for IoT (expected for 3GPP 5G Phase 2) in the future. FIG. 1b represents the basic Core Network Elements for this architecture: Access and Mobility Management Function (AMF), Session Management Function (SMF) (similar to PGW Control Plane), User Plane Function (similar to PGW User Plane), Network Exposure Function (NEF) (similar to SCEF).

Besides, the Mobile Network Operator (MNO) business model, which is based on service exposure, is a significant part of the MNOs revenue related to the cost calculation for transmitted data service between the networks.

Such kind of calculation for inter-operator accounting and settlement is based on the measurement of the volume of the transmitted data per data connection for the APN with the corresponding PDN context as well as for the dedicated bearer for individual Service Data Flows (SDF), or Protocol Data Unit (PDU) session in 5G. This kind of measurement was essential because of the increased data usage in the EPS networks due to the enabling of video streams for the usage of social media by the customers. The data measurement and calculation in mobile networks is based on counting of the volume of the provided service via User Plane (UP) which is expressed in Quota.

With the access evolution on IoT, new customer profile was created, which in particular brings new business options for customers with very small data transfer rates, e.g. for sensors. The current Charging solutions for data transfer is based on volume based measurement of the connections in down and uplink directions which has been enhanced to cover big data transfers. This calculation concept does not make sense for charging of small data delivery and no concept to solve it is currently available in the 3GPP standards.

### SUMMARY OF THE INVENTION

It is an object of the present invention to improve the prior art.

According to a first aspect of the invention, there is provided an apparatus, comprising at least one processor, at least one memory including computer program code, and the at least one processor, with the at least one memory and the computer program code, being arranged to cause the apparatus to at least perform at least monitoring if one of an input payload for a subscription and an output payload from the subscription is delivered; incrementing a payload counter by 1 if one of the input payload and the output payload is delivered; providing the payload counter and an identifier of the subscription to a charging system at at least one of a predefined time and a predefined event.

The payload counter may comprise an input payload counter and an output payload counter; the input payload counter is incremented by 1 if the input payload for the subscription is delivered; and the output payload counter is incremented by 1 if the output payload from the subscription is delivered.

The at least one memory and the computer program code may be arranged to cause the apparatus to further perform resetting the payload counter after the payload counter is provided to the charging system.

According to a second aspect of the invention, there is provided an apparatus, comprising at least one processor, at least one memory including computer program code, and the at least one processor, with the at least one memory and the computer program code, being arranged to cause the apparatus to at least perform at least monitoring if a value of a payload counter and a related identifier of a subscription are received, wherein the payload counter indicates a number of times at which one of an input payload for the subscription and an output payload from the subscription is delivered; generating charging information related to the subscription based on the payload counter.

The payload counter may comprise an input payload counter and an output payload counter; the input payload counter indicates a number of times the input payload for the subscription is delivered; and the output payload counter indicates the number of times the output payload from the subscription is delivered.

The at least one memory and the computer program code may be arranged to cause the apparatus to further perform checking if the value of the payload counter is within a predetermined range; triggering a first activity if the value of the payload counter is not in the predetermined range.

The value of the payload counter may be received related to a time interval, and the at least one memory and the computer program code may be arranged to cause the apparatus to further perform calculating a delivery frequency based on the value of the payload counter and the time interval; checking if the delivery frequency is within a predetermined range; triggering a second activity if the delivery frequency is not in the predetermined range.

Plural values of the payload counter may be received; each of the plural values may be related to a different time interval, and the at least one memory and the computer program code may be arranged to cause the apparatus to further perform analyzing the plural values with respect to a time behavior; triggering a third activity if the time behavior shows a predefined pattern.

The respective one of the first activity, the second activity, and the third activity is at least one of issuing an alarm, and reporting the respective one of the value of the payload counter, the delivery frequency, and the pattern.

The respective one of the first activity, the second activity, and the third activity may be instructing an actor or a control entity of the actor to perform a respective predefined action, wherein the respective predefined action is suitable to modify a future value of the payload counter.

The respective predefined action may be at least one of increasing or decreasing a temperature if the device is a temperature sensor; barring or releasing a road and/or adapting a road sign if the device is a traffic sensor; and filling a liquid into a vessel or discharging the liquid from the vessel if the device is a liquid sensor monitoring a filling level of the vessel.

According to a third aspect of the invention, there is provided a method, comprising monitoring if one of an input payload for a subscription and an output payload from the subscription is delivered; incrementing a payload counter by 1 if one of the input payload and the output payload is delivered; providing the payload counter and an identifier of the subscription to a charging system at at least one of a predefined time and a predefined event.

The payload counter may comprise an input payload counter and an output payload counter; the input payload counter is incremented by 1 if the input payload for the subscription is delivered; and the output payload counter is incremented by 1 if the output payload from the subscription is delivered.

The method may further comprise resetting the payload counter after the payload counter is provided to the charging system.

According to a fourth aspect of the invention, there is provided a method, comprising monitoring if a value of a payload counter and a related identifier of a subscription are received, wherein the payload counter indicates a number of times at which one of an input payload for the subscription and an output payload from the subscription is delivered; generating charging information related to the subscription based on the payload counter.

The payload counter may comprise an input payload counter and an output payload counter; the input payload counter indicates a number of times the input payload for the subscription is delivered; and the output payload counter indicates the number of times the output payload from the subscription is delivered.

The method may further comprise checking if the value of the payload counter is within a predetermined range; triggering a first activity if the value of the payload counter is not in the predetermined range.

The value of the payload counter may be received related to a time interval, and the method may further comprise calculating a delivery frequency based on the value of the payload counter and the time interval; checking if the delivery frequency is within a predetermined range; triggering a second activity if the delivery frequency is not in the predetermined range.

Plural values of the payload counter may be received; each of the plural values may be related to a different time interval, and the method may further comprise analyzing the plural values with respect to a time behavior; triggering a third activity if the time behavior shows a predefined pattern.

The respective one of the first activity, the second activity, and the third activity may be at least one of issuing an alarm, and reporting the respective one of the value of the payload counter, the delivery frequency, and the pattern.

The respective one of the first activity, the second activity, and the third activity may be instructing an actor or a control entity of the actor to perform a respective predefined action, wherein the respective predefined action is suitable to modify a future value of the payload counter.

Each of the methods of the third and fourth aspects may be a method of charging.

According to a fifth aspect of the invention, there is provided a computer program product comprising a set of instructions which, when executed on an apparatus, is configured to cause the apparatus to carry out the method according to any of the third and fourth aspects. The computer program product may be embodied as a computer-readable medium or directly loadable into a computer.

According to some embodiments of the invention, at least one of the following advantages may be achieved:
Charging for IoT subscriptions (which can be devices, group of devices, IoT applications, external Identifiers) is simplified;
Overload of charging system due to many CDRs, one CDR per payload, may be avoided;
A new option to control IoT devices and/or their environment.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1a shows a LTE architecture with SCEF;

FIG. 1b shows a 5G architecture with NEF;

FIG. 2 shows an apparatus according to an embodiment of the invention;

FIG. 3 shows a method according to an embodiment of the invention;

FIG. 4 shows an apparatus according to an embodiment of the invention;

FIG. 5 shows a method according to an embodiment of the invention;

FIG. 6 shows an apparatus according to an embodiment of the invention.

FIG. 7 shows a protocol extension according to an embodiment of the invention;

FIG. 8 shows a protocol extension according to an embodiment of the invention;

FIG. 9 shows a protocol extension according to an embodiment of the invention; and

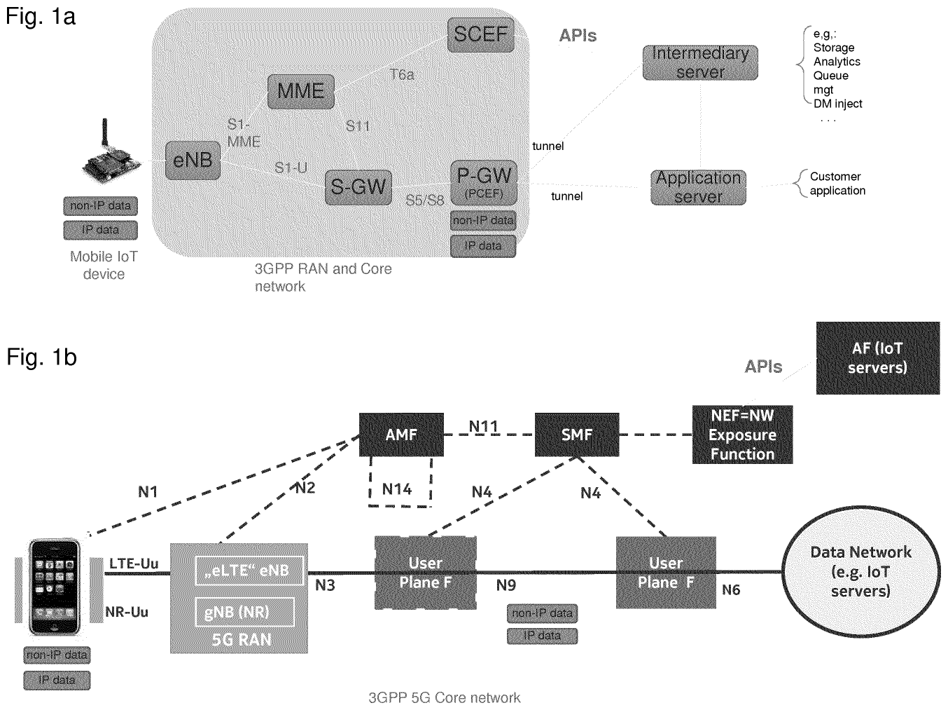

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

According to some embodiments of the invention, a new count for the measurement and calculation for Non-IP Data Delivery (NIDD) is established. It may be used for the charging model of any small data business, e.g. for the payload of sensors or for application which are not focusing on media. According to these embodiments, the transfer of non-media and small data will be counted and recorded in charging as number of payload deliveries.

In some embodiments of the invention, the number of deliveries in the access network is counted which would bring a new business option on Mobile IoT (MIoT) in the different areas of Spectrum used for IoT: e.g. LPWA technologies operating in licensed spectrum such as LTE-M, NB-IoT and EC-GSM-IoT, and LPWA technologies operating in in unlicensed radio spectrum as well, such as RPMA, LoRaWAN and Sigfox.

In some embodiments of the invention, the charging system may evaluate and analyse the payload content itself. However, this needs to be clarified in conjunction with the country specific regulation authority.

In some embodiments of the invention, this new type of measurement (i.e. number of deliveries) may be taken into account on execution basis for billing purposes and, in addition, for new value added services. For example, one may supervise the number of deliveries via analytics and trigger a corresponding real-time interaction. Thus, operators may collect data which enrich the enterprise business model, potentially even without inspecting the payload itself.

Such application may be favourably implemented in an OCS, due to the real-time characteristics of the CDR data transfer from the network elements to the OCS. However, if the delays due to the CDR data transfer to OFCS are acceptable, such application may be implemented in OFCS, too.

The analytics of the deliveries may be based on at least one of the number of deliveries, a frequency of the deliveries (e.g. compared to the average frequency), and a time behaviour of the deliveries (e.g. compared with an expected time behaviour within a dedicated timeframe).

For example, if the number or the frequency of deliveries is outside a predetermined range (e.g. exceeds a certain value), an activity may be triggered. Such an activity may be reporting the value and/or issuing an alarm.

In some embodiments, the activity may be suitable to influence the number of deliveries. That is, some embodiments of the invention actively control the environment of the IoT device and/or the IoT device itself.

Some example use cases are as follows:

Traffic: a traffic sensor (IoT device) may detect bridge usage and report each time if a frequency of cars (or of trucks only) exceeds a certain value. If such message is sent, the application may limit the number of cars (trucks) on the bridge by adapting corresponding traffic signs.

Correspondingly, based on the number of received payloads from another traffic sensor being an IoT device, the number of lanes released per direction may be controlled.

As a still further example, parking slots may be managed based on the number of deliveries from sensors (IoT devices) reporting if a status of a parking slot is changed (from occupied to free and/or vice versa)

Sensors: The IoT device may be a temperature sensor reporting only if the temperature is outside a predefined range, e.g. above a certain limit. In case of such a delivery, the application according to some embodiments of the invention may instruct a cooling device to cool the environment of the temperature sensor.

In another example, the IoT device may be a temperature sensor supervising the heaters and/or air-condition of a house. If it is detected that the outdoor temperature is outside a predefined range (e.g. below a limit), it is expected that the heater and/or air condition starts to operate within a predefined time frame, which may be reported by an inner-circle report. If such inner-circle report is missing within the predetermined time frame and the temperature is reported to be outside the predefined range, an alarm may be generated. Correspondingly, if the IoT device is a liquid filling sensor reporting only if the filling level is outside a predefined range, the application may, based on the number of deliveries, instruct a control device to open or close some valves, to start or to stop a pump, etc.

As a still further example according to some embodiments of the invention, a network operator may provide the NIDD (Non-IP data delivery) for a rental car company renting cars of certain types. The rental car operator may offer analytics option to the car vendors to get a better rent. In addition to the communication service provided by the operator to the rental car company, the operator may offer the collected payload analytics (e.g. based on deliveries) for the differentiation of the brand of the rental car company while relieving the rental car company from the effort for analytics. A typical benefit of the rental company in respect of customer experience could be the compare of gas consumption between the car vendors to improve the environment by a preference on environmentally friendly cars.

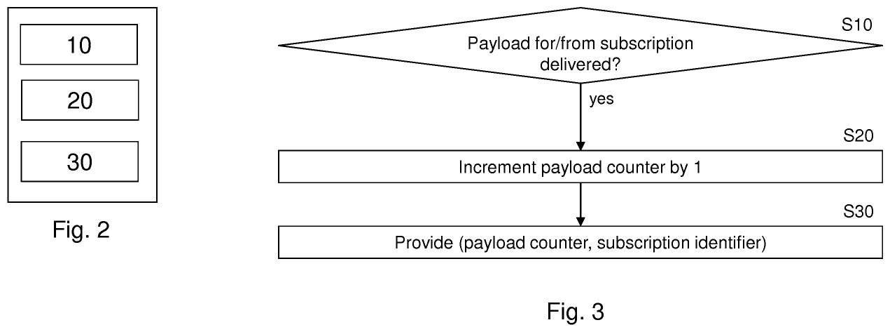

FIG. 2 shows an apparatus according to an embodiment of the invention. The apparatus may be a gateway such as a PGW, a SCEF, a NEF, or a SMF or an element thereof. FIG. 3 shows a method according to an embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises monitoring means 10, incrementing means 20, and providing means 30. The monitoring means 10, incrementing means 20, and providing means 30 may be monitoring processor, incrementing processor, and providing processor, respectively.

The monitoring means 10 monitors if one of an input payload for a subscription and an output payload from the subscription is delivered (S10).

If one of the input payload and the output payload is delivered (S10=“yes”), the incrementing means increments a payload counter by 1. The payload counter may comprise two (sub-)counters, one for input payload and one for output payload. In this case, the respective one of the (sub-) counters is incremented if an input payload or an output payload is delivered. If both an input payload and an output payload are delivered, the payload counter is incremented by 2 (each of the (sub-)counters by 1, if applicable).

The providing means 30 provides the payload counter and an identifier of the subscription to a charging system at at least one of a predefined time (e.g. periodically) and a predefined event (e.g. upon request) (S30).

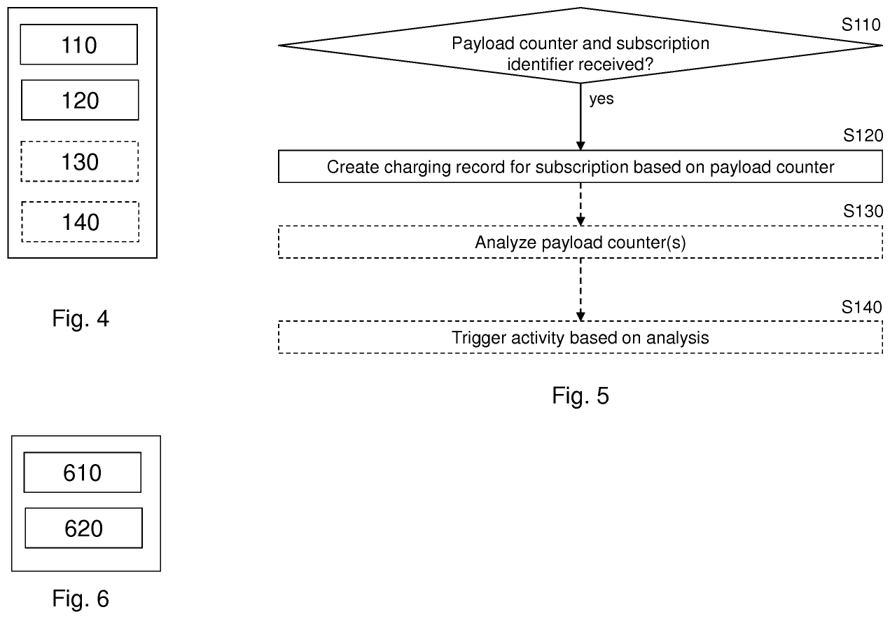

FIG. 4 shows an apparatus according to an embodiment of the invention. The apparatus may be a charging system such as a OCS or OFCS, or an element thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises monitoring means 110 and generating means 120. The monitoring means 110 and generating means 120 may be monitoring processor and generating processor, respectively.

In addition, the apparatus may comprise analyzing means 130 and triggering means 140. The analyzing means 130 and triggering means 140 may be analyzing processor and triggering processor, respectively. These means and the corresponding S130 and S140 are shown by dashed lines because they are optional.

The monitoring means 110 monitors if a value of a payload counter and a related identifier of a subscription are received (S110). The payload counter indicates a number of times at which one of an input payload for the subscription and an output payload from the subscription is delivered.

Based on the payload counter received in S110, the generating means 120 generates charging information related to the subscription (S120).

If available, the analyzing means 130 may analyze the payload counter (S130). E.g., the analyzing means may analyze each value of the payload counter separately, and/or it may comprise a sequence of received payload counters for the device. As a result of the analysis, the analysis means may decide if the payload counter or the sequence of payload counter values fulfills a respective predefined condition (e.g. payload counter outside a predefined range, or sequence of payload counter values shows predetermined pattern).

Based on the analysis result, the triggering means 140 may trigger a respective predefined activity (S140), such as reporting the value of the payload counter or issuing an alarm. In some embodiments of the invention, the triggering means 140 may trigger an action suitable to influence a future value of the payload counter.

FIG. 6 shows an apparatus according to an embodiment of the invention. The apparatus comprises at least one processor 610, at least one memory 620 including computer program code, and the at least one processor 610, with the at least one memory 620 and the computer program code, being arranged to cause the apparatus to at least perform at least one of the methods according to FIGS. 3 and 5.

The following technical specifications in 3GPP are related to the extension of the measurement from data traffic to payload deliveries.

3GPP TS 23.401 “EPC Network Architecture” is the overall architecture specification and the primary reference for the trigger of charging functions for Offline and Online Charging for data traffic in the Charging model.

The evolution of the EPC network architecture for Non-IP Data Delivery (NIDD) with the SCEF is specified in 3GPP TS 23.682.

3GPP TS 23.501 “System Architecture for the 5G System” is the overall architecture specification and the primary reference for 5G.

The used Charging model in 3GPP is specified 3GPP TS 32.240 “Charging architecture and principles” with the specific description for the EPC bearer traffic of PDN connections in 3GPP TS 32.251 and for small data in 3GPP TS 32.253 “Control Plane Data Transfer charging”.

The new objects for the measurement may be defined in the Diameter Charging protocol as specified in 3GPP TS 32.299 “Diameter Charging applications” as well as in the Charging Data Record (CDR) in ASN.1 format specified in 3GPP TS 32.298.

The details on the extension on the AVP definitions of the Diameter Charging protocol may be described separately for Offline Charging for the AVPs in Diameter Accounting application and for Online Charging for the AVPs in Diameter Credit-Control Application (DCCA).

The following section shows the extension of the AVP definitions that may be used for Accounting application and DCCA. If some embodiments of the invention will be standardized, these specifications may be adapted as shown in bold in the following sections:

The Traffic-Data-Volumes AVP (AVP code 2046) is of type Grouped. Its purpose is to allow the transmission of the IP-CAN bearer container, on encountering change on charging condition for this IP-CAN bearer. This container reports the volume count (separated for uplink and downlink). The 3GPP-Charging-Id AVP for the IP-CAN bearer is included when charging per IP-CAN session is active.

```
Traffic-Data-Volumes :: = < AVP Header: 2046>
  [ QoS-Information ]
  [ Accounting-Input-Octets ]
  [ Accounting-Output-Octets ]
  [ Payload-Input-Count ]
  [ Payload-Output-Count ]
  [ Change-condition ]
  [ Change-Time ]
  [ 3GPP-User-Location-Info ]
  [ UWAN-User-Location-Info ]
  [ 3GPP-Charging-Id ]
  [ Presence-Reporting-Area-Status ]
  [ User-CSG-Information ]
  [ 3GPP-RAT-Type ]
  [ Access-Availability-Change-Reason ]
  [ Related-Change-Condition-Information ]
  [ Diagnostics]
  [ Enhanced-Diagnostics ]
  [ CP-CloT-EPS-Optimisation-Indicator ]
  [ Serving-PLMN-Rate-Control ]
```

The Service-Data-Container AVP (AVP code 2040) is of type Grouped. Its purpose is to allow the transmission of the container to be reported for Flow based Charging in PCEF or application based charging in Traffic Detection Function (TDF). On encountering change on charging condition in Flow based Charging, this container identifies the volume count (separated for uplink and downlink), elapsed time or number of events, per service data flow identified per rating group or combination of the rating group and service id within an IP-CAN bearer. On encountering change on charging condition in application based Charging, this container identifies the volume count (separated for uplink and downlink), elapsed time or number of events, per rating group or combination of the rating group and service identifier within a TDF session.

```
Service-Data-Container :: = < AVP Header: 2040>
  [ AF-Correlation-Information ]
  [ Charging-Rule-Base-Name ]
  [ Accounting-Input-Octets ]
  [ Accounting-Output-Octets ]
  [ Payload-Input-Count ]
  [ Payload-Output-Count ]
  [ Local-Sequence-Number ]
  [ QoS-Information ]
  [ Rating-Group ]
  [ Change-Time ]
  [ Service-Identifier ]
  [ Service-Specific-Info ]
  [ ADC-Rule-Base-Name ]
  [ SGSN-Address ]
  [ Time-First-Usage ]
  [ Time-Last-Usage ]
  [ Time-Usage ]
*[ Change-Condition]
  [ 3GPP-User-Location-Info ]
  [ 3GPP2-BSID ]
  [ UWAN-User-Location-Info ]
  [ Sponsor-Identity ]
  [ Application-Service-Provider-Identity ]
  [ Presence-Reporting-Area-Status ]
  [ User-CSG-Information ]
  [ 3GPP-RAT-Type ]
  [ Related-Change-Condition-Information ]
  [ Serving-PLMN-Rate-Control ]
  [ APN-Rate-Control ]
```

### For the Diameter AVP Definition of Small Data Via SCEF

The NIDD-Submission AVP (AVP code 3928) is of type Grouped and holds information about the NIDD submission for CP data transfer.

NIDD-Submission :: = < AVP Header: 3928>
[ Submission-Timestamp ]
[ Event-Timestamp ]
[ Accounting-Input-Octets ]
[ Accounting-Output-Octets ]
[ Payload-Input-Count ]
[ Payload-Output-Count ]
[ Change-Condition ]

In Online Charging is the Multiple-Services-Credit-Control AVP used in the DCCA as the central AVP and Payload counts may be defined as follows:

The Multiple-Services-Credit-Control AVP (AVP code 456) is of type grouped as specified in RFC 4006 [402]. It contains additional 3GPP specific charging parameters.

```
Multiple-Services-Credit-Control ::= < AVP Header: 456 >
  [ Granted-Service-Unit ]
  [ Requested-Service-Unit ]
* [ Used-Service-Unit ]
  :
```

The Used-Service-Unit AVP (AVP code 446) is of type grouped as specified in RFC 4006 [402]. It contains additional 3GPP specific charging parameters.

```
Used-Service-Unit ::= < AVP Header: 446 >
  [ Reporting-Reason ]
  [ Tariff-Change-Usage ]
  [ CC-Time ]

[symbol]

  [ CC-Total-Octets ]
  [ CC-Input-Octets ]
  [ CC-Output-Octets ]
  [ CC-Input-Payloads ]
  [ CC-Output- Payloads ]
  [ CC-Service-Specific-Units ]
*[ Event-Charging-TimeStamp ]

[symbol]

```

The following AVPs from the IETF may be added to TS 3GPP 32.299 and modified accordingly:

| CC-Unit-Type AVP extended with new values: | |
|---|---|
| TIME | 0 |
| MONEY | 1 |
| TOTAL-OCTETS | 2 |
| INPUT-OCTETS | 3 |
| OUTPUT-OCTETS | 4 |
| SERVICE-SPECIFIC-UNITS | 5 |
| INPUT-PAYLOADS | 6 |
| OUTPUT-PAYLOADS | 7 |

```
Requested-Service-Unit ::= <AVP Header: 437 >
  [ CC-Time ]
  [ CC-Money ]
  [ CC-Total-Octets ]
  [ CC-Input-Octets ]
  [ CC-Output-Octets ]
  [ CC-Input-Payloads ]
  [ CC-Output- Payloads ]
  [ CC-Service-Specific-Units ]

[symbol]

Granted-Service-Unit ::= < AVP Header: 431 >
  [ Tariff-Time-Change ]
  [ CC-Time ]
  [ CC-Money ]
  [ CC-Total-Octets ]
  [ CC-Input-Octets ]
  [ CC-Output-Octets ]
  [ CC-Input-Payloads ]
  [ CC-Output- Payloads ]
  [ CC-Service-Specific-Units ]

[symbol]

```

The final recording for the analytics may be based on the extension of the CDR parameter definition in ASN.1 following the rules which are specified in 3GPP TS 32.298:

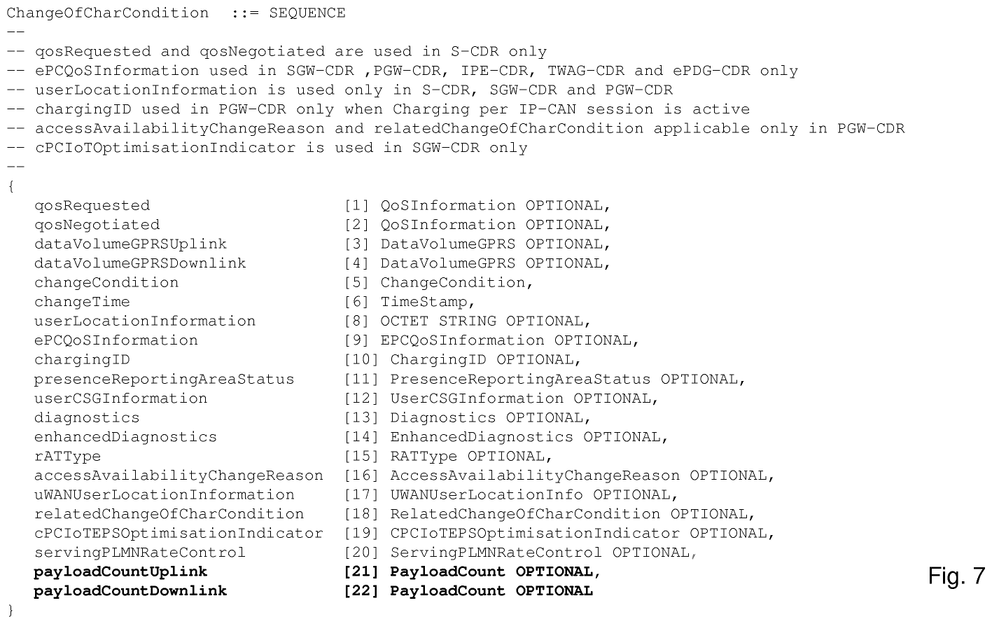

For small data transfer in a PDN connection via SGi interface (tunnel), the extension shown in bold in FIG. 7 may cover the recordings.

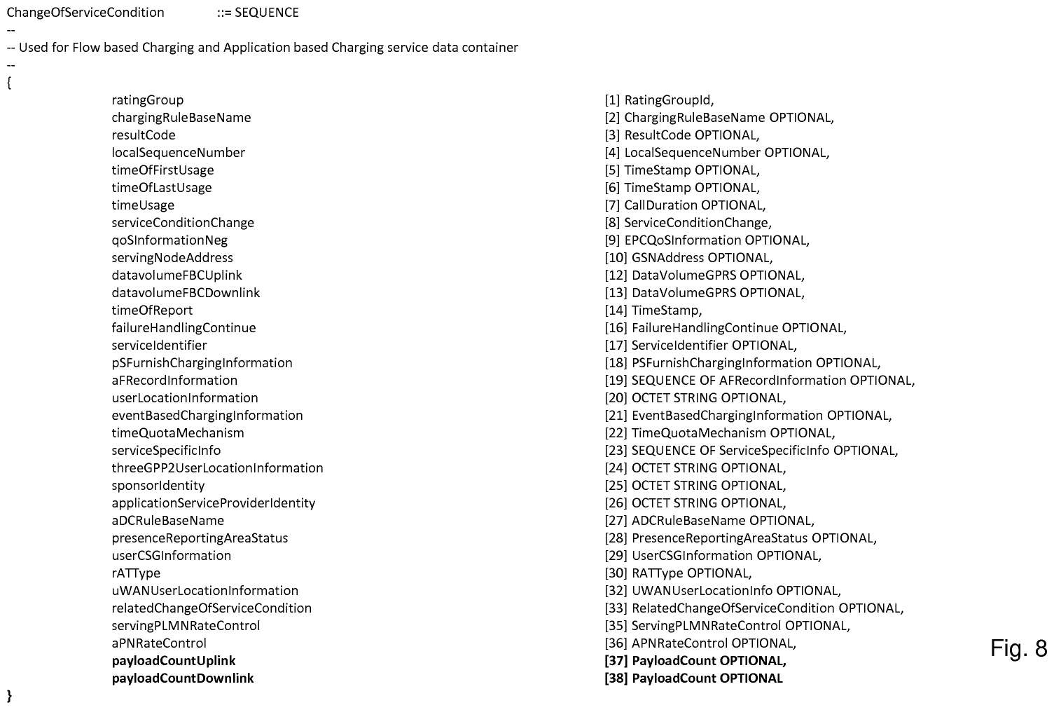

For small data transfer in a Service Data Flow (SDF) via SGi interface, the extension shown in bold in FIG. 8 may cover the recordings.

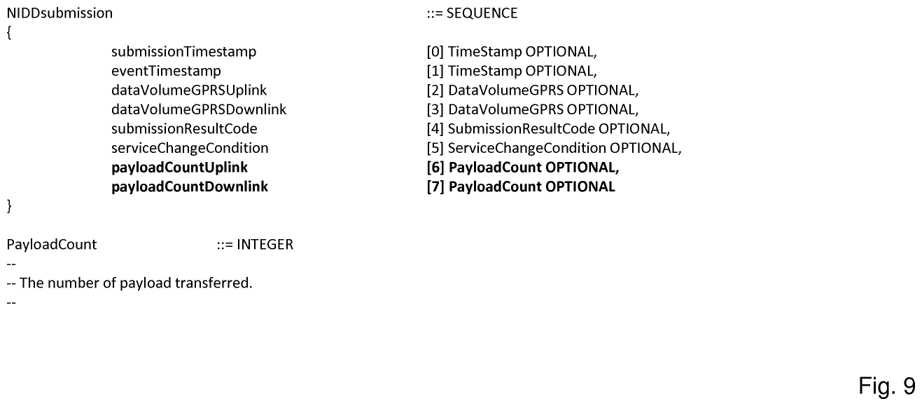

For the CDR parameter definition of NIDD via SCEF, the extension shown in bold in FIG. 9 may cover the recordings.

The above shown modifications are example proposals only. In particular, the respective parameter number of the proposed extension and the names of the parameters may be different from that shown in the above proposals. These detailed proposals are not to be considered as limiting in any way.

Embodiments of the invention may be used for NIDD. However, the invention is not restricted to NIDD. E.g., in some embodiments of the invention, the number of deliveries of IP traffic may be counted.

Embodiments of the invention may be employed in a 3GPP network such as LTE or LTE-A, or in a 5G network. They may be employed also in other wireless or wireline communication networks such as CDMA, EDGE, UTRAN networks, WiFi networks, etc. In particular, embodiments of the invention may not be applied to mobile networks only, but also to fixed networks. This might be particularly useful if IoT devices are connected via WLAN or LAN to a router, which is connected via fixed line (e.g. DSL or a variant thereof) to the network.

A terminal may be any apparatus capable to access the respective network. E.g., in 3GPP networks, a terminal may be a UE, an IoT device, etc. The terminal may be a smartphone, a laptop, a mobile phone, a sensor, a module etc. In particular, embodiments of the invention may be applied to non-IoT devices, too.

A subscription may be related to a device (such as a terminal), a group of devices, an IoT application, an external identifier, or any other identifier for a service function. For example, a subscription may be related to a user of a device. One or more subscriptions may be related to one device. One subscription may be related to one or more devices.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. One or more of the described entities may be implemented in the cloud. In particular, each of the described entities may be implemented as a network slice.

According to the above description, it should thus be apparent that example embodiments of the present invention provide, for example, a gateway function, such as a PGW or a SCEF or a NEF or a SMF, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, an charging system, such as a OCS or a OFCS, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. They may be implemented fully or partly in the cloud.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1.-22. (canceled)

23. An apparatus comprising:
at least one processor; and
at least one memory including computer program code, where the at least one memory and the computer program code are configured, with the at least one processor, to cause the apparatus to at least:
monitor if one of an input payload for a subscription and an output payload from the subscription is delivered;
increment a payload counter by 1 if one of the input payload and the output payload is delivered; and
provide the payload counter and an identifier of the subscription to a charging system at at least one of a predefined time and a predefined event.

24. The apparatus of claim 23, wherein
the payload counter comprises an input payload counter and an output payload counter;
the input payload counter is incremented by 1 if the input payload for the subscription is delivered; and
the output payload counter is incremented by 1 if the output payload from the subscription is delivered.

25. An apparatus comprising:
at least one processor; and
at least one memory including computer program code where the at least one memory and the computer program code are configured, with the at least one processor, to cause the apparatus to at least:
monitor if a value of a payload counter and a related identifier of a subscription are received, wherein the payload counter indicates a number of times at which one of an input payload for the subscription and an output payload from the subscription is delivered; and
generate charging information related to the subscription based on the payload counter.

26. The apparatus of claim 25, wherein
the payload counter comprises an input payload counter and an output payload counter;
the input payload counter indicates a number of times the input payload for the subscription is delivered; and
the output payload counter indicates the number of times the output payload from the subscription is delivered.

27. The apparatus of claim 25, wherein the at least one memory including the computer program code is configured, with the at least one processor, to cause the apparatus to:
check if the value of the payload counter is within a predetermined range;
trigger a first activity if the value of the payload counter is not in the predetermined range.

28. The apparatus of claim 25, wherein
the value of the payload counter is received related to a time interval, and the at least one memory including the computer program code is configured, with the at least one processor, to cause the apparatus to:
calculate a delivery frequency based on the value of the payload counter and the time interval;
check if the delivery frequency is within a predetermined range; and
trigger a second activity if the delivery frequency is not in the predetermined range.

29. The apparatus of claim 25, wherein
plural values of the payload counter are received;
each of the plural values is related to a different time interval, and the at least one memory including the computer program code is configured, with the at least one processor, to cause the apparatus to:
analyze the plural values with respect to a time behavior; and
trigger a third activity if the time behavior shows a predefined pattern.

30. The apparatus of claim 27, wherein the respective one of the first activity, the second activity, and the third activity is at least one of
issuing an alarm, and
reporting the respective one of the value of the payload counter, the delivery frequency, and the pattern.

31. The apparatus of claim 27, wherein the respective one of the first activity, the second activity, and the third activity is
instructing an actor or a control entity of the actor to perform a respective predefined action, wherein the respective predefined action is suitable to modify a future value of the payload counter.

32. A method, comprising:
monitoring if one of an input payload for a subscription and an output payload from the subscription is delivered;
incrementing a payload counter by 1 if one of the input payload and the output payload is delivered;
providing the payload counter and an identifier of the subscription to a charging system at at least one of a predefined time and a predefined event.

33. The method of claim 32, wherein
the payload counter comprises an input payload counter and an output payload counter;
the input payload counter is incremented by 1 if the input payload for the subscription is delivered; and
the output payload counter is incremented by 1 if the output payload from the subscription is delivered.

34. A method, comprising:
monitoring if a value of a payload counter and a related identifier of a subscription are received, wherein the payload counter indicates a number of times at which one of an input payload for the subscription and an output payload from the subscription is delivered;
generating charging information related to the subscription based on the payload counter.

35. The method of claim 34, wherein
the payload counter comprises an input payload counter and an output payload counter;
the input payload counter indicates a number of times the input payload for the subscription is delivered; and
the output payload counter indicates the number of times the output payload from the subscription is delivered.

36. The method of claim 34, further comprising
checking if the value of the payload counter is within a predetermined range;
triggering a first activity if the value of the payload counter is not in the predetermined range.

37. The method of claim 34, wherein
the value of the payload counter is received related to a time interval, and the method further comprises
calculating a delivery frequency based on the value of the payload counter and the time interval;
checking if the delivery frequency is within a predetermined range;
triggering a second activity if the delivery frequency is not in the predetermined range.

38. The method of claim 34, wherein
plural values of the payload counter are received;
each of the plural values is related to a different time interval, and the method further comprises
analyzing the plural values with respect to a time behavior;
triggering a third activity if the time behavior shows a predefined pattern.

39. The method of claim 36, wherein the respective one of the first activity, the second activity, and the third activity is at least one of
issuing an alarm, and
reporting the respective one of the value of the payload counter, the delivery frequency, and the pattern.

40. The method according to of claim 36, wherein the respective one of the first activity, the second activity, and the third activity is
instructing an actor or a control entity of the actor to perform a respective predefined action, wherein the respective predefined action is suitable to modify a future value of the payload counter.

41. A non-transitory computer-readable medium storing program code, the program code executed by at least one processor to perform the method of claim 32.

42. A non-transitory computer-readable medium storing program code, the program code executed by at least one processor to perform the method of claim 34.
